(19) United States
(12) Patent Application Publication
(10) Pub. No.: US 2005/0073426 A1
(43) Pub. Date: Apr. 7, 2005

(54) Deployable emergency alert system

(76) Inventor: Thomas Nelson Hines, Grand Rapids, MI (US)

Correspondence Address: Robert J. Sayfie, Suite 407, 161 Ottawa Ave. NW, Grand Rapids, MI, 49503, US

(21) Appl. No.: 10/808,217

(22) Filed: Mar. 24, 2004

Related U.S. Application Data
(60) Provisional application No. 60/456,515, filed on Mar. 24, 2003.

(51) Int. Cl. G08B 3/00

(52) U.S. Cl. 340/691.1

(57) ABSTRACT

A temporarily deployable and re-deployable alert unit and system. The unit able to automatically detect self-diagnostic and alert conditions. Also alert conditions can be manually entered. The condition is transmitted to a remote station. Alert conditions also turn on alarms and lights locally, i.e. on the unit. A dispersed sensor can be deployed near the unit to also detect alert conditions, and transmit this information to the deployable alert unit for local annunciation and transmission to the remote station. The system also incorporates software for use with the remote station. Different transceiver configurations allow for different transmission of data, (1) land data for data communication via land-based antennas; (2) land voice enabled for voice and data communication via land-based antennas; (3) satellite data for data communication via space satellites; and (4) satellite voice enabled for voice communication via space satellites.

### CROSS-REFERENCE TO RELATED APPLICATION

This application claims the benefit of U.S. Provisional Patent Application Ser. No. 60/456,515, filed 24 Mar. 2003, which is incorporated herein by reference.

### FIELD OF THE INVENTION

The invention relates to a wireless emergency alert system, and more particularly, to a system that is temporarily deployable and re-deployable.

### BACKGROUND OF THE INVENTION

Personnel working in certain environments have a particular need for a deployable and re-deployable alert system. For example, there regularly exists a need for police, fire departments, or security personnel to be dispatched to environments such as outside construction and utility sites. Conventionally, cellular phones are used. However, cellular phones require good reception and the ability to verbally communicate the situation to the listener. Also, cellular phones regularly have non-reception areas, where they can not be used.

There exists a need for an automatic or simple alerting to personnel, such as the police, fire departments, or security personnel. This need exists in urban areas, sub-urban areas, rural areas, remote areas such as military installations, war zones, during planetary travel, or while exploring other planets, in deep sea environments, or while working or boating on large bodies of water.

The deployable alert unit automatically detects an emergency situation, or it responds to manual input, and broadcasts a local alarm, and/or sends a wireless signal to activate a remote alarm.

The deployable alert unit can be used as a system that includes dispersed sensors, also called nodes, that communicate with other dispersed sensors, and the deployable alert unit.

The system can also employ a remote base station, such as at a dispatch center, or a remote mobile station, such as a handheld device. Also, system software provides processing, response, and management of telemetry from and to the deployable alert unit, dispersed sensors, remote base station, and remote mobile station.

Multiple embodiments of the deployable alert unit and system are disclosed herein. It will be understood that other objects and purposes of the invention, and variations thereof, will be apparent upon reading the following specification and inspecting the accompanying drawings.

### BRIEF SUMMARY OF THE INVENTION

The present invention solves the problems of ineffective emergency communications from work sites to proper response personnel. Use of the applicant's invention enables the proper personnel to be alerted to various conditions, and the location of the various conditions.

The system comprises components including (1) a deployable alert unit, (2) a transceiver, (3) an alert input means, (4) a location identification means, (5) an alert broadcast receiving means, and (6) an alert output means. The system can be expanded to include (1) dispersed sensors or nodes, (2) a remote base station, (3) a remote mobile station, and (4) system software. All of these components need not be used simultaneously. For example, the system can be used with a deployable alert unit, a remote base station, and system software.

The deployable alert unit, dispersed sensors, remote base station, and mobile base station obtain power from batteries within each component. Alternatively they can be solar powered, powered by fuel cells, or plugged into a standard electrical outlet.

### BRIEF DESCRIPTION OF THE DRAWINGS

FIG. 1 is a pictorial assembly view of a deployable alert unit.

FIG. 2 is a pictorial view of the rear of the deployable alert unit.

FIG. 3 is a pictorial view of the front of the deployable alert unit.

FIG. 4 is a set of views 4A, 4B, 4C, 4D, 4E, and 4F, which are views from the normal of the six planes of a cube.

FIG. 5 is a schematic of the entire deployable alert unit system.

FIG. 6 is a pictorial assembly view of the unit.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

### DETAILED DESCRIPTION

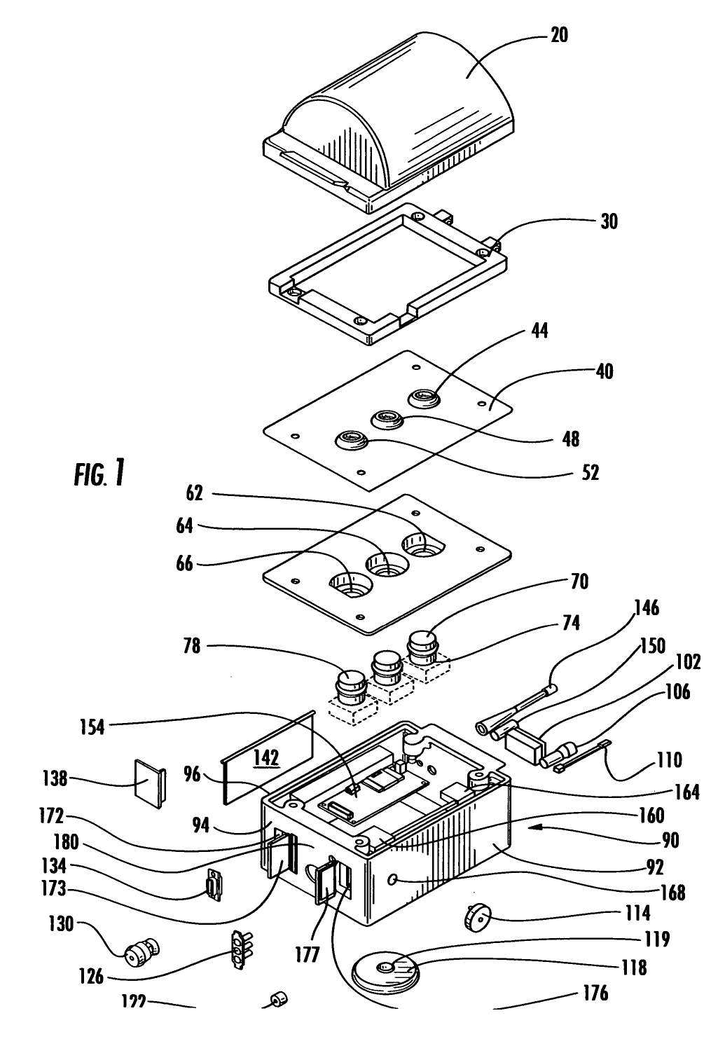

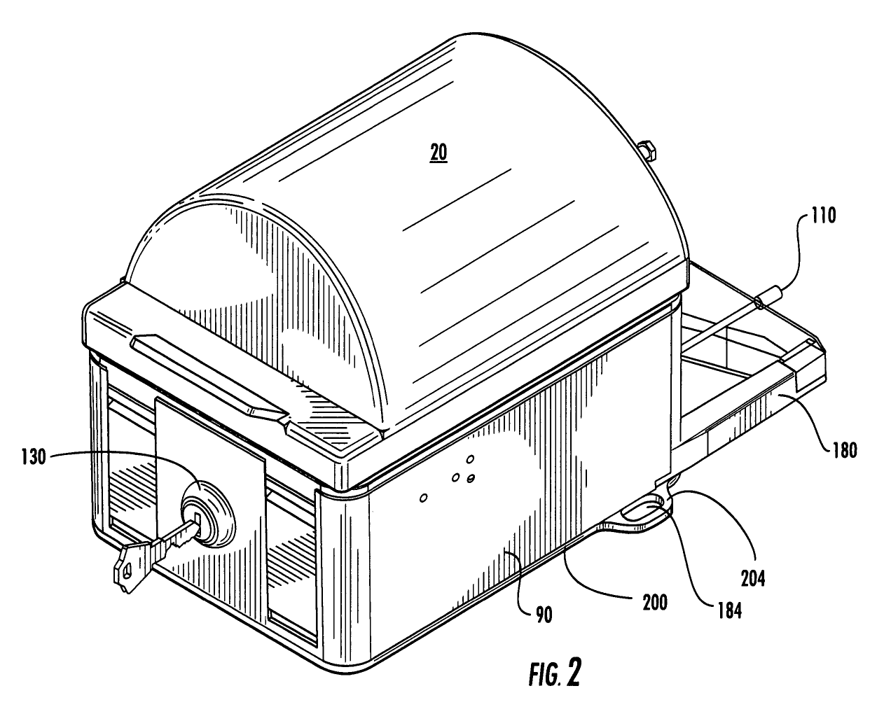

Referring to FIG. 1, a housing 90 of a first embodiment of a temporarily deployable and re-deployable alert unit 10 is illustrated. The housing 90 has sides 92, 94, 96, 98 that incorporate several features. Such as a voice speaker portion 168, a battery chamber 143, with associated hingedly openable battery cover 142, jack assembly chamber 176 for fixedly mounting a jack assembly (not shown), with associated hingedly openable jack assembly chamber door 177, a key switch aperture 174, a piezo alert portion 190, and a data connector chamber 172 for fixedly mounting a data connector (not shown), with associated hingedly openable data connector chamber door 173 and data port cover 138. The voice speaker portion 168 and piezo alert portion 190 can be an opening, or it can be a material that is sound permeable, to maintain a hermetically sealed environment within the housing 90.

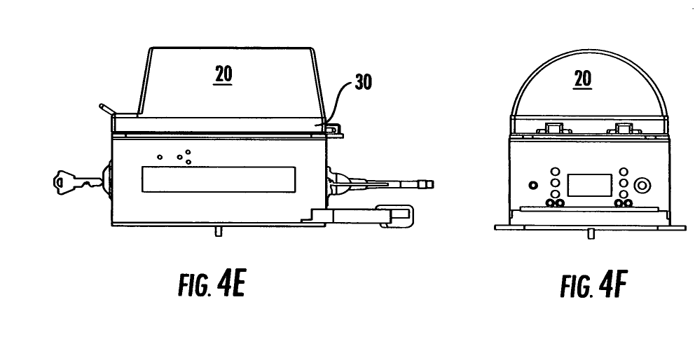

Referring to FIG. 4C, the bottom of the housing 90 has a back panel 100 having a magnet cavity 101 for receiving a cup magnet 99, which is utilized in the device's tamper switch assembly 118.

Other features of the housing 90 include its bright colors and highly visible graphics and indicia, such as “EMERGENCY,” and other indicators for the deployable alert unit's 10 various system status points, also known as operational and status states, such as “Battery level,” secure connection conditions, such as “Remote Antenna Port.” In the preferred embodiment, the housing 90 is made of high impact plastic.

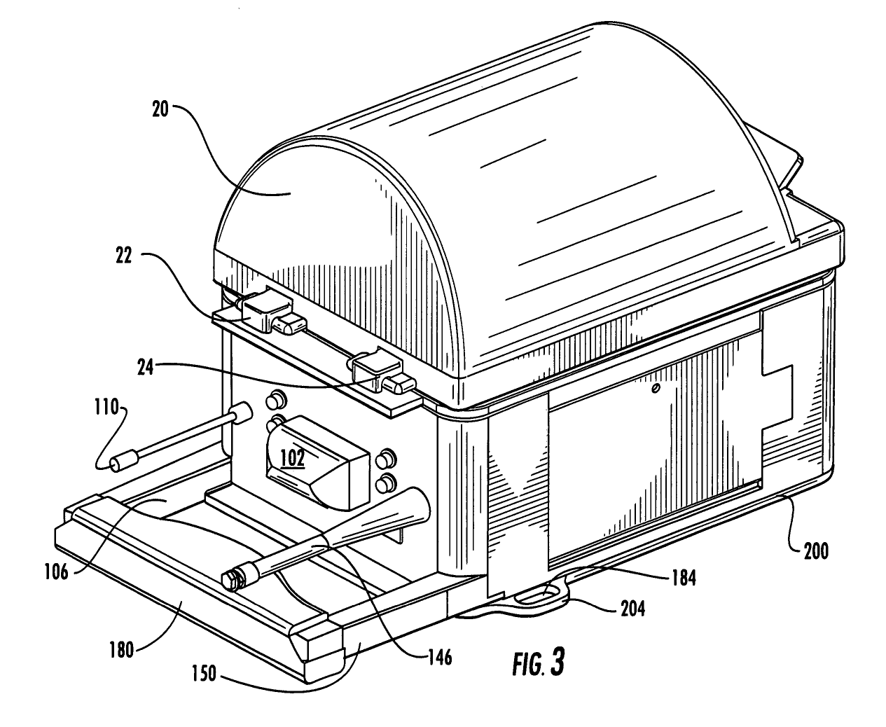

Referring to FIG. 2, the housing 90 has a different embodiment from that as shown in FIG. 1. In FIG. 2, the housing 90 has a portion 200 that has a widened portion 204 with a tie down aperture 184 therein. There are two tie down apertures 184 on opposed sides of the housing 90 bottom portion 200. In this second embodiment of FIGS. 2, 3, and 4, a handle 180 extends away from the housing 90 from side 98. This handle 180 incorporates LED's 106, 150, within the handle 180. Another embodiment of the handle 180 incorporates a photo cell so the LEDs 106, 150 illuminate the handle in low level lighting environments. The key switch aperture 174 is disposed on the opposed side 94 of the housing 90. The handle is also used to remove the unit if it is magnetically attached to something, i.e. the side of a work trailer.

As shown in FIG. 1, a push button mounting plate 60 is fixedly secured to the housing 90. The push button mounting plate 60 defines the top of the housing 90. The push button mounting plate 60 has three apertures, a first button aperture 62, a second button aperture 64, and a third button aperture 66. The apertures 62, 64, 66 respectively receive a first button, 70, a second button 74, and a third button 78. These three buttons 70, 74, 78 can be designated and used for (1) medical, (2) fire, or (3) police alert notification. Other embodiments have more or less buttons, thus more or less apertures, respectively. For example a fourth button can be incorporated for “service.”

A graphic membrane 40 is fixedly mounted atop and to the push button mounting plate 60. The graphic membrane 40 covers the buttons 70, 74, 78. However the graphic membrane 40 has a pliable material disposed adjacently above said buttons 70, 74, 78 so the buttons can be depressed. This also aids in sealing the internal components of the housing 90. In the preferred embodiment, the buttons are illuminated.

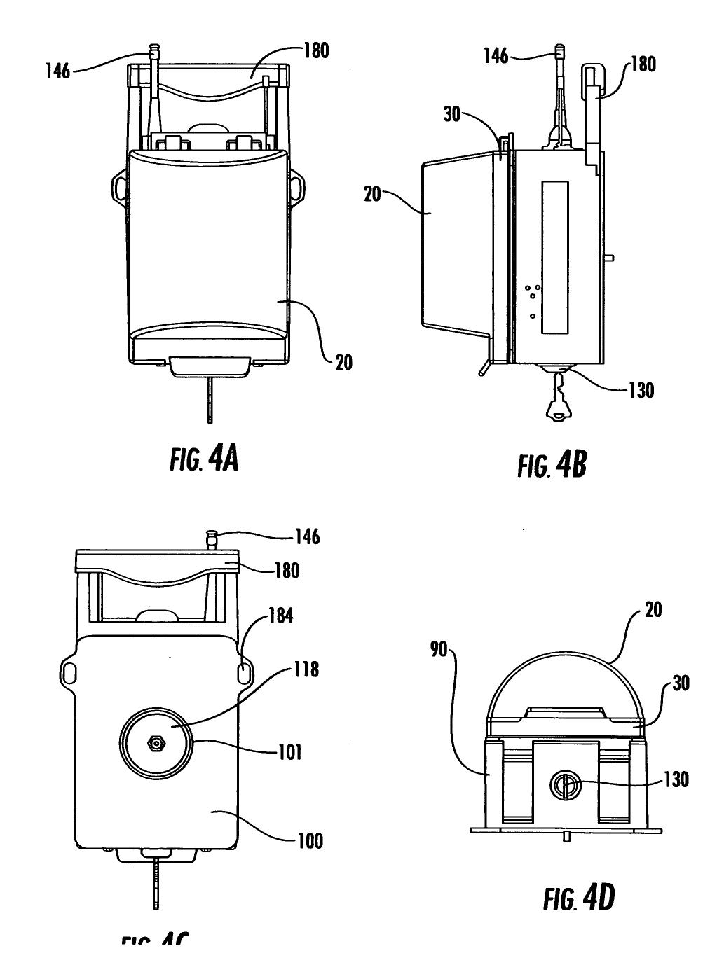

A cover frame 30 is fixedly mounted to an upper side of the graphic membrane 40. Above the cover frame 30, a hinged safety cover 20 is hingedly connected to the cover from 30. As shown in FIG. 3, the hinged safety cover 20 has two hinges 22 and 24, which allow the hinged safety cover 20 to pivot forwardly when opened. When the hinged safety cover 20 is opened, the button(s) 70, 74, 78 can be depressed.

Referring to FIGS. 1 and 3, a radio frequency (RF) antenna 146 extends from the front of the side 98 of the housing 90. Similarly, a cellular antenna 110 also extends from the housing 90. Further, a strobe light 102 also extends from the housing 90.

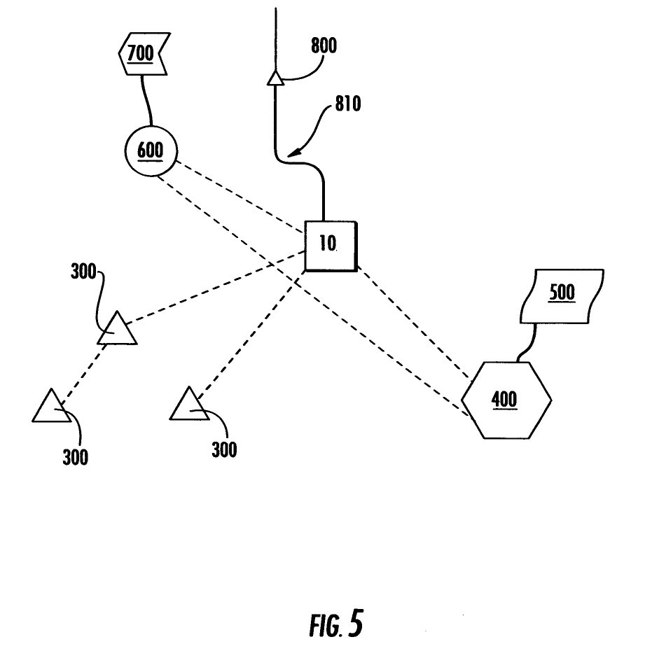

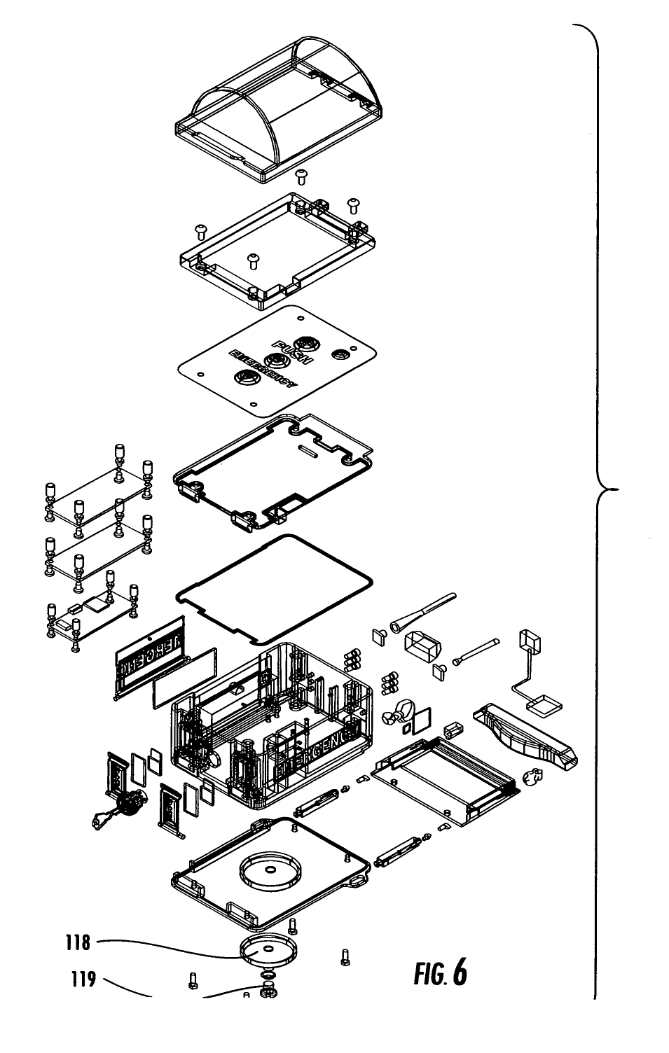

As seen in FIGS. 1 and 2, a key switch 130 is fixedly mounted within the key switch aperture 174 on the side 94 of the housing 90. The key switch 130 has three positions, “off,” “on,” and “register.” With a key, the key switch 130 can be set to “off” or “on.” However if the key switch 130 is set to “register,” then it biases to the “on” position after sending telemetry to a remote station, such as a remote base station 400 or a remote mobile station 600, as seen in FIG. 5. In other words, while the key switch 130 is at the “register” position, the telemetry is sent. Then after biasing to “on,” the deployable alert unit 10 is in standby mode, ready for manual or automatic activation. Lights or alarms on the unit are activated during the registration process to notify the user that registration is taking place. For example, the lights may blink slower than during an actual emergency alert. During the registration process, telemetry data is uploaded to a remote base station or a remote mobile station.

The back 100 of the unit 10 has a magnet cavity 101. The tamper switch assembly 118 has a cup magnet 99 fixedly disposed within the magnet cavity 101. In the preferred embodiment, the cup magnet is a cup style ceramic magnet that is fixedly secured within a stainless steel cup. The stainless steel cup is then fixedly secured within the magnet cavity 101, whereby the back 100 and magnet 99 are flush with each other. This aids in reducing or eliminating problems that can occur from undesirable magnetic forces and fields within the housing 90. The tamper switch assembly 118 also includes a sealed reed magnet plunger style tamper switch 119. One such tamper switch is presently sold by George Risk Industries. To operate the tamper switch assembly 118, the unit 10 is secured to a surface. It can use the cup magnet 99 for securing the surface, but it need not be secured via magnetic attraction for the tamper switch assembly 118 to work. Once the unit 10 is set in place, the key switch 130 is turned to “register” the unit 10, which also sets or turns the tamper switch assembly 118 on. Upon un-attachment or removal of the deployable alert unit 10, the tamper switch 118 activates the logic or command processor, which activates an alert output means, such as the piezo alarm or piezo audible alert 122, the light emitting diodes (LED) 106, 150, or strobe light 102. Further, the tamper switch 118 would activate the applicable wireless transceiver 154 to provide local and remote annunciation of the tamper condition. Local annunciation is an alarm sounding at the deployable alert unit. Remote annunciation is an alarm sounding at either the remote base station 600, or the remote mobile station 400.

The housing 90, push button mounting plate 60, graphic membrane 40 and the other housing features such as the jack assembly and data connector are sealed with grommets, gaskets, seals, and sealants such as silicone glue to withstand extreme variances in outdoor conditions. Other embodiments include the application of Goretex® over the piezo alert portion or piezo opening 190, and over the voice speaker portion or speaker opening 176 or over the buttons 70, 74, 78. In one embodiment, the unit can be submerged in water. For example during deep sea exploration or construction. In such an embodiment, the remote antenna assembly 800 can be disposed above the water surface, while connected to the unit 10 via a remote antenna assembly cable 810.

As shown in FIG. 5, a remote antenna 800 and the remote antenna cable 810 has a plug which removably couples with the remote antenna jack within the jack assembly chamber 176. The jacks and plugs have four separate configurations that correspond to said four transceiver configurations. The four transceiver configurations are (1) land data, (2) land voice, (3) satellite data, and (4) satellite voice, which will be discussed in more detail below.

The deployable alert unit 10 can be configured to be field programmable, but not entirely field repairable. Each unit 10 can be identified by a separate identification number. Thus some repairs may take place on the field, and others are restricted, so as to prevent field repair for some conditions.

Within the housing 90 are standoffs for internal mounting of various components. Mounted within the housing 90 are circuit boards (transceiver(s), logic/command processor, circuit interface, location identification means, such as a GPS receiver), battery(ies), light emitting diodes (LEDs) for function and diagnostic indication. A piezo alarm or piezo audible alert 122 is disposed within the housing 90 adjacent the piezo alert portion 190 of the housing 90. Within the data connector chamber 172 is the data connector assembly, which in the preferred embodiment is a 9-pin jack.

The antennas 110, 146 are connected within the housing 90 to the applicable transceiver. The are four transceiver configurations (1) a land data wireless transceiver fixedly disposed within said housing for data communication via land-based antennas, such as those on land, buildings, and towers, whereby data is transmitted and received; (2) a land voice enabled wireless transceiver fixedly disposed within said housing 90 for use with a microphone and a speaker, both disposed within the housing 90, for voice and data communication via land-based antennas; (3) a satellite data wireless transceiver fixedly disposed within said housing for data communication via space satellites; and (4) a satellite voice enabled wireless transceiver fixedly disposed within said housing for communication via space satellites. Each satellite having uplink and downlink antennas for transmitting and receiving a plurality of signals. The preferred embodiment also includes a means to select the optimum transceiver to broadcast telemetry. This means to select is also fixedly disposed within the housing 90. For example, if a satellite transceiver is preferred over the transceiver used for land based antenna communication, then the means to select detects this, and telemetry is sent via the satellite transceiver.

The user is aware of the alert condition, also referred to as emergency, various system status points, and condition, by the publishing of an alert output means. Publishing refers to the activation of the lights and sounds, or other alert output means. The alert output means includes lights and sounds. In the preferred embodiment, the alert output means is distinctive with respect to the alert or condition. The term alert includes conditions that do not constitute and emergency, such as “register” telemetry, the unit's 10 self diagnostics, and other conditions. The alert output means is disposed both locally and remotely. Local annunciation occurs at the deployable alert unit (10). If an alert condition is determined by an alert input means (locally or from a dispersed sensor described below), then an alert broadcast receiving means, including local annunciation of an emergency alert is activated. Examples of alert input means include manual pushing of buttons, 70, 74, 78, telemetry received by the transceiver 154, or other determination of an alert condition. Such alerts include self-diagnostic problems, such as failure in transmission confirmation, device trouble, low battery level, or tamper. The local annunciation occurs via the piezo audible alert 122, strobe light 102, or LED 106, 150.

Referring to FIG. 5, the alert broadcast receiving means includes remote annunciation, which occurs at the remote base station 400 or the remote mobile station 600. If an alert condition is determined (locally or from a dispersed sensor described below), then the applicable transceiver sends telemetry to either the remote base station 400 or the remote mobile station 600. The remote base station 400 includes a dispatch center having a fixed location. The remote mobile station 600 includes a belt-clipped or hand held device, or a device mounted within a vehicle. In the preferred embodiment, the alert broadcast receiving means triggers an alarm distinctive for each alert condition, and distinctive for certain non-alert conditions, such as “system OK” indication, and during the “register” process.

The deployable alert unit 10 can be programmed to send or receive data on a scheduled, or on-demand basis.

Referring to FIG. 5, the system comprises the deployable alert unit 10, dispersed sensors 300, the remote base station 400 with accompanying software 500, the remote mobile station 600 with accompanying software 700.

Dispersed sensors 300 provide automatic or manual activation of alert or trouble conditions to the alert input means of the deployable alert unit 10. The dispersed sensors 300 are positioned near said deployable alert unit 10. They can have peer-to-peer communication with other dispersed sensors 300. After receipt via the alert input means, any self-diagnostic or alert condition generated by the dispersed sensor 300 is then received by the alert broadcast receiving means and annunciated by the deployable alert unit, or the remote base 400 or remote mobile 600 station. The dispersed sensor 300, as well as the deployable alert unit 10 can have an array of sensors disposed therein, such as sensors to detect radioactivity, airborne hazards, smoke, environmental hazards, biohazards, liquid levels, meteorogical conditions, temperature, gas concentrations, panic (man-down), biological conditions of an entity, such as a person, equipment status, and other conditions or situations. The dispersed sensor 300 has a bright, light-reflective yellow with easy to read bright graphics for user instructions and operational status. It also has a handle for easy transport and detachable mounting. The dispersed sensor 300 can be hermetically sealed. Also, it, like the deployable alert unit 10, can have a tamper switch 118. Further, the dispersed sensors have a means for self healing. For example, if a first dispersed sensor 300 is placed to communicate with a second dispersed sensor 300, which is placed for direct communication to the deployable alert unit 10, and then the second dispersed sensor 300 is moved or fails, then the first dispersed sensor 300 will seek another, third dispersed sensor 300, or seek to communicate directly to the deployable alert unit 300, to “self heal” the network.

The remote base station 400 serves as the system's response and management remote base station for reception and transmission from the deployable alert unit 10 and the dispersed sensor 300 (where applicable) and the remote mobile station 600 (where applicable). The remote base station 400 can be used as an independent end-user dispatch center, or it can be integrated within a security company central station, or it can be integrated within a governmentally operated 911 emergency dispatch center. Within the remote base station 400 is a mounted deployable alert unit 10 that is interfaced into a computer platform, such as a single standalone PC, multiple PC workstations in a LAN/WAN network, or a wall projection or large screen displays. The remote base station 400 is configured to adapt to the four transceivers: (1) a land data wireless transceiver fixedly disposed within said housing for data communication via land-based antennas, such as those on land, buildings, and towers, whereby data is transmitted and received; (2) a land voice enabled wireless transceiver fixedly disposed within said housing 90 for use with a microphone and a speaker, both disposed within the housing 90, for voice and data communication via land-based antennas; (3) a satellite data wireless transceiver fixedly disposed within said housing 90 for data communication via space satellites; and (4) a satellite voice enabled wireless transceiver fixedly disposed within said housing 90 for communication via space satellites. The remote base station 400 is connected to the computer platforms by a remote base station's 400 9-pin data port jack. The remote base station 400 is powered by a plug-in power supply with battery back-up, or battery, or solar power, wind power, radioactive energy, or any combination thereof. It's data output is processed and made viewable by the system's base software 500, or remote software 700. The software 500, 700 can be installed on the computer, or accessed via the internet or a shared computer or network. The remote base station 400 has wall or roof mounted antennas (not shown), corresponding to the four transceiver configurations. The antennas are plugged into said base station's 400 remote antenna assembly port.

The remote mobile station 600 is the system's mobile device for reception or transmission from the deployable alert unit 10, and the dispersed sensor 300, and the remote base station 400. The remote mobile station 600 provides mobile communications between in-field service personnel and dispatch center personnel. It can incorporate Windows CE®, or handheld PC software interfaced to its own wireless transceiver(s) and GPS receiver, configured to the four transceivers discussed in detail above. Remote software 700 is used for Windows CE® or handheld PC use. The remote mobile station 600 is transported in, for example, a belt holster or a vehicle mounted cradle with battery power and a plug in power adapter, and battery charger.

The remote base station 400 and remote mobile station 600 can also transmit or “poll” the deployable alert unit 10 and dispersed sensors 300 via their own transceivers.

The system software, specifically the remote software 700 or the base software 500, provides processing, response, and management of telemetry from and to the deployable alert unit 10, dispersed sensor 300, remote base station 600, and remote mobile station 400. The software 500, 700 has an application that operates on multiple Windows® operating systems and SQL® databases. A mapping feature is integrated in order to provide a geographical view of the locations of the deployable alert unit 10, dispersed sensor 300, remote base station 400 and remote mobile station 600. The software's 500, 700 functionality includes alert and response instructions for all applicable telemetry as well as system and device management data, instructions, and report functionality.

Although a particular preferred embodiment of the invention has been disclosed in detail for illustrative purposes, it will be recognized that variations or modifications of the disclosed apparatus, including the rearrangement of parts, changes in sizes and dimensions, variances of properties lie within the scope of the present invention. For example, all of the antennas herein, may be omni-directional antennas. Where appropriate a transceiver is interchangeable with a cellular module packet. Electrical connection means either a hard wired connection or wireless connection.

The deployable alert unit, dispersed sensors, remote base station, and mobile base station obtain power from batteries within each component. Alternatively they can be solar powered, powered by fuel cells, or plugged into a standard electrical outlet.

1. An emergency alert system comprising:
a deployable alert unit having a housing;
a transceiver secured within said housing;
an activatable alert input means electrically connected to said transceiver; and
a location identification means to transmit the location of the deployable alert unit, said location identification means secured within said housing and electrically connected to said transceiver; and
an alert output means to alert users of an alert condition, whereby when said alert input means is activated, said transceiver sends a signal to an alert output means.

2. The emergency alert system of claim 1, further comprising:
an alert broadcast receiving means, whereby when said alert input means is activated, said transceiver sends a signal to said alert broadcast receiving means, said signal including both data to identify the location of the alert unit and a second batch of data corresponding to said alert input means, for publishing by said alert output means.

3. The emergency alert system of claim 1, further comprising:
said location identification means consisting of a global positioning system, having a global positioning receiver and antenna.

4. The emergency alert system of claim 1, further comprising:
said alert input means being a button.

5. The emergency alert system of claim 1, further comprising:
a tamper switch assembly wherein said housing has a magnet cavity disposed within a back of said housing;
a cup magnet fixedly disposed within said magnet cavity, said cup magnet having an aperture centrally disposed therethrough; and
a tamper switch within said housing, extending through said aperture;
whereby if said magnetic mounting and tamper switch is placed on a surface that creates a magnetic attraction with said magnetic mounting and tamper switch, and if said magnetic mounting and tamper switch is activated, then upon removal of said deployable alert unit, said magnetic mounting and tamper switch activates said alert input means.

6. The emergency alert system of claim 1, further comprising:
said alert broadcast receiving means consisting of a local alert unit.

7. The emergency alert system of claim 1, further comprising:
said alert output means consisting of either a piezo audible alarm, a speaker, or a light.

8. The emergency alert system of claim 1, further comprising:
said transceiver being either a land data wireless transceiver for communication via land-based antennas, or a land voice enabled wireless transceiver for communication via land-based antennas, or a satellite data wireless transceiver for data communication via space satellites, or a satellite voice enabled wireless transceiver for communication via space satellites.

9. The emergency alert system of claim 1, further comprising:
said alert broadcast receiving means consisting of a remote alert unit.

10. The emergency alert system of claim 1, further comprising:
said alert input means comprising a cellular antenna fixedly secured to the housing, and extending away from the housing, said cellular antenna also being connected to said transceiver.

11. The emergency alert system of claim 1, further comprising:
a means to select the optimum transceiver to send telemetry to said alert output means.

12. The emergency alert system of claim 2, further comprising:
a means to select the optimum transceiver to send telemetry to said alert broadcast receiving means.

13. The emergency alert system of claim 1, further comprising:
said housing having a handle portion.

14. The emergency alert system of claim 1, further comprising:
said housing being hermetically sealed.

15. The emergency alert system of claim 1, further comprising:
a remote jack assembly that is accessible on said housing, and a remote alert antenna assembly that removably connects to said remote jack assembly;
whereby said remote alert antenna assembly can be located in an area of acceptable telemetry reception.

16. The emergency alert system of claim 1, comprising:
said alert input means being a dispersed sensor, said dispersed sensor having means to self form connections between said dispersed sensors and said alert unit to self heal breaks between said dispersed sensors.

17. The emergency alert system of claim 1, further comprising:
system software for use with said alert broadcast receiving means to provide processing, response, and management of telemetry from and to said deployable alert unit.

18. An emergency alert system comprising:
a deployable alert unit having a housing;
a first transceiver secured within said housing, said first transceiver being a land data enabled wireless transceiver for communication via land-based antennas;
a second transceiver secured within said housing, said second transceiver being a land voice enabled wireless transceiver for communication via land-based antennas;
a third transceiver secured within said housing; said third transceiver being a satellite data wireless transceiver for data communication via space satellites;
a fourth transceiver secured within said housing, said fourth transceiver being a satellite voice enabled wireless transceiver for communication via space satellites;
an activatable alert input means electrically connected to said transceiver;
a location identification means to transmit the location of the deployable alert unit, said location identification means secured within said housing and electrically connected to said transceiver; and
an alert output means to alert users of an alert condition, whereby when said alert input means is activated, at least one of said transceiver sends a signal to an alert output means.
